(19) United States
(12) Patent Application Publication
(10) Pub. No.: US 2011/0320037 A1
(43) Pub. Date: Dec. 29, 2011

(54) BIOMETRIC PAYMENT AND IDENTIFICATION SYSTEM AND METHOD

(76) Inventor: Jose Frugone, Coral Gables, FL (US)

(21) Appl. No.: 13/082,870

(22) Filed: Apr. 8, 2011

Related U.S. Application Data
(60) Provisional application No. 61/358,468, filed on Jun. 25, 2010.

(51) Int. Cl. G06F 17/00; G06Q 40/00; G06F 7/04

(52) U.S. Cl. 700/237; 340/5.52; 340/5.9; 705/44

(57) ABSTRACT

A biometric payment and identification system includes a vending machine, a biometric reader device communicating with the vending machine, a biometric information database communicating with the biometric reader device and checking software supporting the biometric information database and communicating with the vending machine. The biometric information database is adapted to electronically store biometric information of potential buyers of products contained in the vending machine. The checking software is adapted to authorize dispensing of products from the vending machine by matching biometric information obtained from the customer using the biometric reader device with the biometric information stored in the biometric information database.

### CROSS-REFERENCE TO RELATED APPLICATIONS

This application claims the benefit of U.S. provisional application No. 61/358,468, filed Jun. 25, 2010 and entitled “FINGERPRINT PAYMENT AND IDENTIFICATION SYSTEM AND METHOD, which provisional application is hereby incorporated by reference in its entirety.

### BACKGROUND OF THE DISCLOSURE

1. Field of the Disclosure

The present disclosure relates generally to payment and identification systems. More particularly, the disclosure relates to a biometric payment and identification system and method in which purchase of restricted products such as alcohol or tobacco through a vending machine is authorized using biometric characteristics of a user.

2. Description of the Prior Art

Fingerprints offer a virtually infallible means of personal identification. Therefore, fingerprint identification has supplanted other methods of establishing the identities of suspects after arrest. The science of fingerprint identification stands out among many other forensic sciences for many reasons. Fingerprint identification has served virtually all governments worldwide over the past 100 years to provide accurate identification of suspects. Fingerprint identification continues to expand as the premier method for identifying persons in a variety of applications, with tens of thousands of persons added to fingerprint repositories daily in America alone—far outdistancing similar databases in growth.

In the past, biometric information in the form of fingerprints has been heavily explored for different uses. For example, financial institutions have used fingerprints for replacing signatures and personal identification numbers (PINs). Fingerprints can uniquely identify buyers and authorize payments. Fingerprints are also used by the U.S. Customs, banks, office buildings, company cafeterias, notebook computers and other applications to identify authorized personnel and also as proof of identity in banks when a check is cashed. Some health insurance companies are also using fingerprints to identify their customers in some health centers. However, use of fingerprints or other biometric information to authorize vending machine purchases that require a buyer to meet some criteria or to replace credit and debit cards in normal purchases is not generally known.

Several conventional methods and systems are known for using fingerprints during commercial transactions. For example, a method and system which enables buyers to pay for goods and services using only their fingerprints at the time and location of purchase is based on buyers registering their fingerprints and one or more payment methods such as financial credit cards or bank accounts. One or more of each customer's fingerprints are related to one or more registered convenient rules that will act on behalf of buyers at the time of purchase. The rules select the appropriate payment method based on purchase conditions such as purchase amount, purchase location and purchase time. Buyers can use their fingerprints to instantly pay for purchases where the payment system automatically matches the fingerprint at the time of purchase to registered fingerprints and uses the purchase amount, purchase location and purchase time to evaluate the conditional part of all registered convenient rules related to the matched fingerprint. The action part of one rule is used to select and further charge one or more of the previously-registered payment methods.

Another known system involves a customer computer, a vendor computer and a verification computer interconnected by a network such as the internet. A customer can initiate a transaction such as the purchase of information from a vendor. However, the vendor will not proceed until verification of the transaction has been received from a website. Verification of the transaction is not provided until the customer has sent a unique fingerprint of data to the site identifying the customer computer by reference to hardware device types or serial numbers, software types or licenses, email addresses or the like. This fingerprint is stored for future reference in showing that the transaction was validly implemented by the customer computer.

Another known alternative is an apparatus and process of authorizing an electronic transaction system including a computer located at the site of a transaction, a conversion module for enabling connection between the computer located at the site of the transaction and the conversion module to authorize the transaction, and a connection between the conversion module and the computer at the site of the transaction. The system uses a fingerprint input data panel for obtaining fingerprint input data from a finger impressed on the fingerprint input data panel and then converts the fingerprint input data to characteristic fingerprint points including minutiae. These characteristic fingerprint points including minutiae are used in conjunction with at least one code at the conversion module to encode messages sent across the system.

Also known is a payment system for automatic vending machines that comprises at least one microprocessor or electronic chip which can be suitably programmed to univocally identify the fingerprints of each user of the vending machines by memorization in memory elements and comparison of certain scanning points of their images to effect electronic identification.

In Japan, an association of vending machine companies has created a personal card (Taspo card) that is given to persons after identifying the persons in a database. However, this solution is relatively expensive (the cost of the card). Moreover, the card could be stolen or used by unauthorized persons who do not satisfy the conditions upon which issuance of the cards were based.

Also in Japan, a company uses a facial recognition system to estimate the age of potential buyers prior to authorizing sale of age-restricted products. In Pennsylvania, some vending machines include a camera which is connected to a remote location where an employee can view a buyer and his or her identification card as well as check his or her breath to detect the alcohol level of the buyer's breath and decide whether or not to authorize the transaction.

In Germany, the Federal Association of German Tobacco Wholesalers and Vending Machine Operators Association has implemented credit/debit/ATM card readers in cigarette vending machines to identify the age of potential buyers, in coordination with the bank system, which also work with the European Union Driver License bureau. The debit/credit/ATM cards have a chip on which is stored the age of the buyer. The solution has drawbacks in that a child could use his or her parents' debit/credit cards, not all the adults have a debit/credit card and there is a risk to forget and inadvertently leave the card in the vending machine.

Generally, cigarettes are not available for purchase from vending machines because such sales are banned in most places to prevent access by children, except for sites with liquor licenses such as bars and taverns if the regulation allows it or in other countries using the systems described in paragraphs [0009] and [0011]. Therefore, there are strong limitations to the vending machines authorized to sell cigarettes, alcohol and other controlled products/services due to the unfeasibility of ascertaining whether the buyer complies with the purchasing requirements under the law. In some states, only persons 21 years old or older can buy cigarettes and/or alcohol; therefore, purchase of these products typically requires an ID to ascertain the age of the buyer.

Cigarettes and alcoholic beverages are frequently sold during store hours, which may be inconvenient for some buyers. This may impose limitations on users who are not able to purchase these products after store hours.

Even though the above-cited methods and systems address some of the needs of the market, a fingerprint system for enabling vending machines to dispense restricted products such as cigarettes and alcoholic beverages is still desired.

### SUMMARY OF THE DISCLOSURE

This disclosure is directed to a method and system for dispensing restricted products, like cigarettes and alcoholic beverages through vending machines.

Another aspect of the present disclosure provides a method which may be used to dispense controlled articles such as cigarettes and alcohol 24 hours a day and 7 days a week.

Yet another aspect of the disclosure provides a method for selling restricted products such as cigarettes and alcoholic beverages controlling in 100% of the cases if a buyer satisfies purchase requirements under the law, offering more control to local authorities and to companies interested in delivering products or services to certain people (age, company or club members, customers, etc.).

Another aspect of this disclosure provides a system that allows for the legal sale of restricted products such as cigarettes and alcoholic beverages through vending machines.

Yet another aspect of the disclosure provides a method which may replace credit/debit cards in personal transactions by requiring fingerprint or other biometric verification and authorization of users. This may accrue various advantages related to avoiding the use of a credit card as a payment method including but not limited to the risk of a credit card being stolen, cloned, lost, demagnetized or forgotten when a purchase is desired to be made.

Yet another aspect of the disclosure provides a method of payment with which the fingerprint or other biometric information of a person may be transformed into a number or other entity which is stored in a private data base and associated with his or her bank accounts, credit card accounts or any other payment source. This data base may be connected to the financial institutions using current art systems.

Yet another aspect provides a method for promoting products or services. For example, a car insurance company could offer free products (coffee, maps, etc.) every time a buyer registers in the system and fills up a vehicle fuel tank at certain gas stations. The insurance company could also offer discounts or free products and services to its customers in other stores, identifying the customers with their fingerprints previously recorded in the database of the system. This method may increase cross-promotions, as the identification of the buyer is very easy and 100% secured. Therefore, the risk that false users could be created is avoided. As a result, perfect control of promotions and discounts in service stations and movie theaters, among other promotions, can be obtained.

Yet another aspect of the disclosure provides a method for controlling food, snacks and drinks certain students may consume at a school setting. By establishing a vending machine and a database of the student's fingerprints at a school, it is possible to create an authorization pattern regarding the type and quantity of food and drinks the student obtains from the vending machine and consumes. The vending machine may include a voice device that may play a message such as, for example, “Hi Billy, you already bought two chocolates this week; that is the limit, but you have two candies available”, or any other greeting and relation with personal consumption patterns.

In summary, the present disclosure is related to a fingerprint payment and identification method which allows buyers to use automatic vending machines for buying products such as cigarettes or alcoholic beverages, sales of which are restricted by law or convention according to age or other criteria, by authorizing the buyers using fingerprints or other biometric information obtained from the buyers and previously registered in a private biometric information database to verify the buyer's authority to purchase a restricted product without the need to carry and present financial payment instruments such as a debit/credit card. The method may include (a) creation of a fingerprint record by registering the fingerprints or other biometric information obtained from a user in a private biometric information database; (b) the user's provision of his/her personal information including his/her date of birth (DOB) which is uploaded in the same database; (c) the user's registration of at least one financial payment method that can be used to debit a commercial transaction; (d) provision of at least one vending machine including a fingerprint reader device to a merchant; (e) connection of the vending machine to the database; (f) at the time of purchase, creation of a transaction record that is sent to the database system and may include the following information on the buyer: fingerprint record of the buyer, vending machine identification number, type of product requested by the buyer, time and amount of purchase and payment method selected; (g) comparison of the fingerprint record of the buyer at the time of purchase with the registered fingerprint records to find a matching fingerprint record; (h) if a match is found, checking the payment availability of the buyer; (i) if the buyer complies with the age restrictions and the purchase amount is lower than the credit availability, sending an authorization signal to the vending machine for dispensing the product to the buyer; (j) if the system does not find the matching fingerprint, sending a message to the vending machine informing the buyer that he/she is not a registered user of the system and therefore the product cannot be dispensed; and (k) if the system finds a matching fingerprint record but the funds available are not enough to complete the transaction, sending a message to the vending machine informing the buyer that he/she is a registered user but another payment method must be selected to complete the transaction.

These and other aspects, features, and advantages of the present disclosure will become more readily apparent from the attached drawings and the detailed description of the illustrative embodiments, which follow.

### BRIEF DESCRIPTION OF THE DRAWINGS

The illustrative embodiments of the disclosure will hereinafter be described in conjunction with the appended drawings provided to illustrate and not to limit the disclosure, where like designations denote like elements, and in which:

FIG. 1 is a schematic block diagram of an illustrative embodiment of a biometric payment and identification system in accordance with the present disclosure; and:

FIG. 2 is a block diagram of an illustrative embodiment of a biometric payment and identification method in accordance with the present disclosure.

### DETAILED DESCRIPTION OF REPRESENTATIVE EMBODIMENTS

The disclosure is generally directed to a biometric payment and identification system which allows buyers to use automatic vending machines for purchase of legally restricted products such as cigarettes and alcoholic beverages, for example and without limitation, using biometric information such as fingerprints which is obtained from the buyers and registered in a private biometric information database to determine authorization of the buyer to purchase one of the restricted products. The system may also enable the user to pay for the products without using a financial payment instrument such as a debit/credit card.

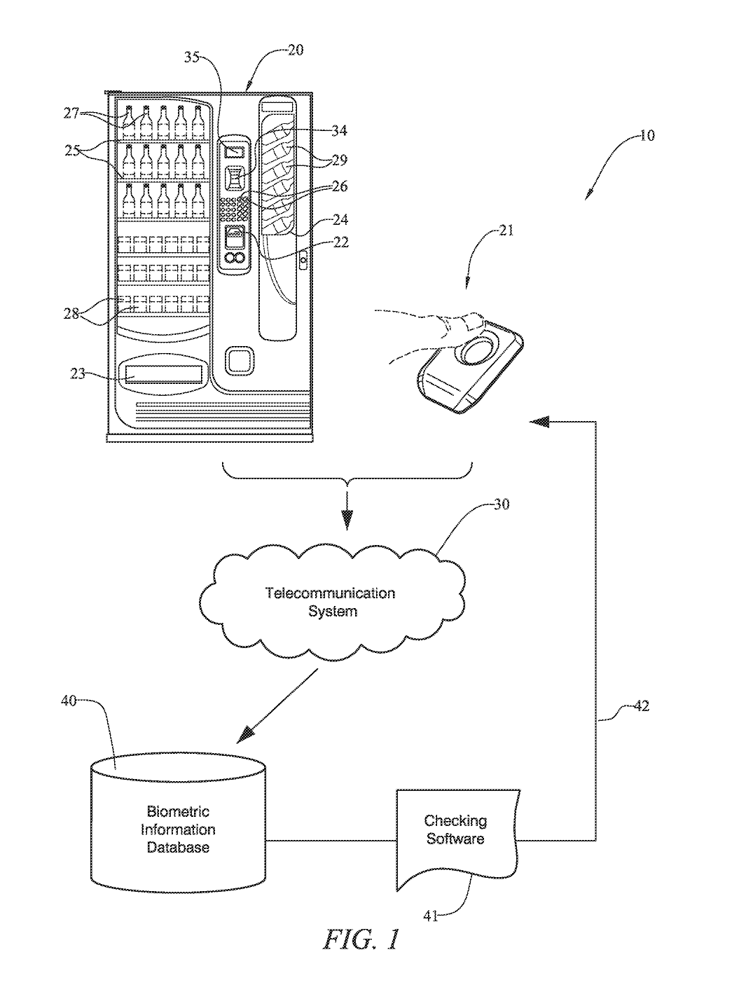

Referring initially to FIG. 1 of the drawings, an illustrative embodiment of the biometric payment and identification system, hereinafter system, is generally indicated by reference numeral 10. The system 10 may include at least one vending machine 20. Each vending machine 20 may include the product storage, display, refrigeration, dispensing and other components and systems which are conventional to vending machines known by those skilled in the art. In some embodiments, the vending machine 20 may contain multiple product shelves 25. The product shelves 25 may be adapted to support multiple liquid products 27. The liquid products 27 may include products the sales of which are restricted by law or convention according to age and/or other criteria. In some applications, the liquid products 27 may include alcoholic beverages. The product shelves 25 may additionally or alternatively be adapted to support multiple solid products 28, sales of which are restricted by law or convention according to age and/or other criteria. In some applications, the solid products 28 may include cigarettes. Additional products 29 may be contained in the vending machine 20. The additional products 29 may include products sales of which may or may not be restricted.

The vending machine 20 may include a transparent display window 24 which enables potential buyers to view the products 27, 28 and 29 in the vending machine 20 for selection and purchase. A dispensing tray 23 may be provided in the vending machine 20 generally beneath the product shelves 25. The dispensing tray 23 may be positioned to receive each product 27, 28 and 29 as the product is individually released from the product shelf 25 which supports the product in selection and dispensing of the product from the vending machine 20, which will be hereinafter described.

The vending machine 20 may include a central panel 22. The central panel 22 may provide a user interface for the selection and dispensing functions of the vending machine 20. Accordingly, the central panel 22 may include multiple product selection buttons 26 which can be depressed or manipulated to select one of the products 27, 28, 29 in the vending machine 20 for dispensing into the dispensing tray 23. In some embodiments, the central panel 22 may further include at least one payment slot 34 which may facilitate payment for a selected one of the products 27, 28, 29 using a selected alternative form of payment. The central panel 22 may include a payment display 35 which displays the dollar amount of the purchase price for the product which is selected for dispensing typically by depression of the product selection buttons 26.

The vending machine 20 may further include a biometric reader device 21 which may be provided on the control panel 22 or elsewhere on the vending machine 20. In some embodiments, the biometric reader device 21 may include a fingerprint reader. In other embodiments, the biometric reader device 21 may include a retinal scanner. In still other embodiments, the biometric reader device 21 may be adapted to read other biometric information from a potential buyer of the products 27, 28, 29 in the vending machine 20.

A telecommunication system 30 may communicate with the biometric reader device 21 of the vending machine 20. The telecommunication system 30 may include wireless transmission components, hardwired transmission components or any combination of wireless transmission components and hardwired transmission components. In various embodiments, the telecommunication system 30 may include cellular telephone systems, satellite systems and/or the Internet, for example and without limitation.

A biometric information database 40 may communicate with the telecommunication system 30. The telecommunication system 30 may be adapted to transmit biometric information which the biometric reader device 21 obtains from a potential buyer of one of the products 27, 28, 29 in the vending machine 20 to the biometric information database 40. The biometric information database 40 may be adapted to electronically store the biometric information. The biometric information database 40 may also be adapted to electrically store personal identification and/or other information of potential buyers such as name, address and Date Of Birth (DOB), for example and without limitation, of each potential buyer. The biometric information database 40 may additionally be adapted to electrically store payment information such as credit or debit card information or bank account information, for example and without limitation, for each potential buyer.

The biometric information database 40 may be supported with checking software 41 which is adapted to verify and confirm or deny the authorization of each potential buyer to purchase a product 27, 29 from the vending machine 20. Accordingly, the checking software 41 may have the capability to determine the age of a potential buyer and verify whether the potential buyer is of legal age to purchase a restricted product 27, 28, 29 from the vending machine 20. The checking software 41 may additionally have the capability to debit the purchase price of a product 27, 28, 29 which is selected by a potential buyer for purchase from the vending machine 20 from the credit card, debit card, bank account or other means of payment of the potential buyer which was pre-stored in the biometric information database 40. The checking software 41 with supporting hardware of the biometric information database 40 may have the capability to transmit an authorization signal 42 to the vending machine 20 in the event that the potential buyer is authorized to purchase the product 27, 28, 29 from the vending machine 20. Responsive to receiving the authorization signal 42, the vending machine 20 may be adapted to dispense the product 27, 28, 29 which was selected by the potential buyer for purchase into the dispensing tray 23 such that the buyer can access the product 27, 28, 29.

Exemplary application of the system 10 may be as follows:

(a) A user of the system 10 and potential buyer of one of the products 27, 28, 29 in the vending machine 20 initially creates a biometric record by registering his/her biometric information such as his or her fingerprints, for example and without limitation, in the biometric information database 40. In some applications, fingerprints of a user may be obtained from public sources depending on legality.
(b) The user may also provide his or her personal information which may include his/her DOB, for example and without limitation, and the personal information is uploaded into the biometric information database 40. It is understood that in order to utilize the system 10, the user may be required to comply with requirements stated by law for purchase of the restricted products 27, 28, 29 in the vending machine 20. Accordingly, it may be required that a user be at least 21 years of age since sale of alcohol products in many states requires that purchasers of alcohol be at least 21 years of age. During the registration process, the user may be required to present an ID which is approved by the authorities, for example, a valid driver's license.
(c) In some applications, the user may also register at least one financial payment method that can be used to debit a commercial transaction in purchase of a product 27, 28, 29 from the vending machine 20. This financial payment method may include a credit/debit card or a bank account (savings or checking), for example and without limitation. In other applications, the system 10 may not require registration of a financial payment method. In those applications, if the buyer meets the requirement for a restricted product 27, 28, 29, the vending machine 20 may require a financial payment method such as cash, credit card or debit card, for example and without limitation, which the user can execute at the vending machine 20 to effect purchase and dispensing of the selected product 27, 28, 29.
(d) The vending machine 20 is linked to the biometric information database 40 typically via the telecommunication system 30. In some applications, the biometric information database 40 may be a component part of the vending machine 20 in the form of a chipset, memory card or the like.
(f) At the time of purchase, the biometric reader device 21 obtains biometric information from the user. For example, the user may provide a fingerprint by pressing one of his or her fingers against the biometric reader device 21. The user views the products 27, 28, 29 in the vending machine 20 through the display window 24. The user selects one of the products 27, 28, 29 for consumption typically by depression of one or more of the product selection buttons 26 on the central panel 22. Accordingly, the vending machine 20 creates a transaction record that is sent to the biometric information database 40. The transaction record may include the following information: fingerprint record of the buyer, vending machine identification number, type of product requested by the buyer, time, date and amount of purchase, payment method selected, and any other necessary information.
(g) The checking software 41 compares the biometric information which is obtained from the potential buyer at the time of purchase with the registered biometric information records in an attempt to find a matching fingerprint record. This checking process may utilize known recognition routines that are well-known in the prior art.
(h) If a matching record is found, then the checking software 41 may determine whether the potential buyer complies with the restriction or restrictions which govern purchase of a restricted product 27, 28, 29 from the vending machine 20 by law or convention. The checking software 41 may also ascertain any method of payment which may have been previously provided to the biometric information database 40 by the buyer. This step may be accomplished by checking information which was pre-stored in the database 40 or by connecting the checking software 41 to any suitable credit/debit card processing software.
(i) If the potential buyer complies with the age and/or other restrictions which govern sale of the selected product 27, 28, 29 and the purchase amount of the product is lower than the credit availability of the buyer, the checking software 41 transmits an authorization signal 42 to the vending machine 20 for dispensing of the selected product 27, 28, 29 to the buyer. Furthermore, in some applications, a ticket (not illustrated) may be printed by the vending machine 20, to provide proof of purchase to the buyer.
(j) If the checking software 41 does not find a matching fingerprint or if the record associated with the matching fingerprint indicates that the potential buyer does not comply with the restrictions placed on purchase of the product 27, 28, 29, the checking software 41 may transmit a message to the vending machine 20 informing the potential buyer that he/she is not a registered user of the system or does not comply with the age and/or other purchasing restrictions of the product and that the product cannot therefore be dispensed.
(k) If the checking software 41 finds a matching fingerprint record in the biometric information database 40 but the funds or credit available is not sufficient to complete the transaction, the checking software 41 may transmit a message the vending machine 20 informing the potential buyer that he/she is a registered user but another payment method must be selected to complete the transaction. In such a case, the buyer can use any other traditional payment method usually accepted at vending machines such as cash or credit/debit card, which the user may execute using the payment slot 34 on the central panel 22 of the vending machine 20.

In an exemplary application of the system 10, the vending machine 20 may include a voice device for playing customized messages. For example and without limitation, the system 10 may play a message which is similar to the following when a user registered in the database 40 accesses the vending machine 20: “Hi Joseph, this week we have chocolate brand XX on sale” or “I have not seen you in the last two weeks, would you like a coffee as last time?” or any other promotion or personal message related to previous purchases or products.

It will be appreciated by those skilled in the art that the vending machine 20 may sell non-restricted products such as candies, soda and chocolate, for example and without limitation, as well as restricted products such as alcoholic beverages and cigarettes, for example and without limitation, to the general public. Sales of the non-restricted products to children in a school or other setting may be subject to certain rules as a weight control method, for example, or to offer free promotions and the like.

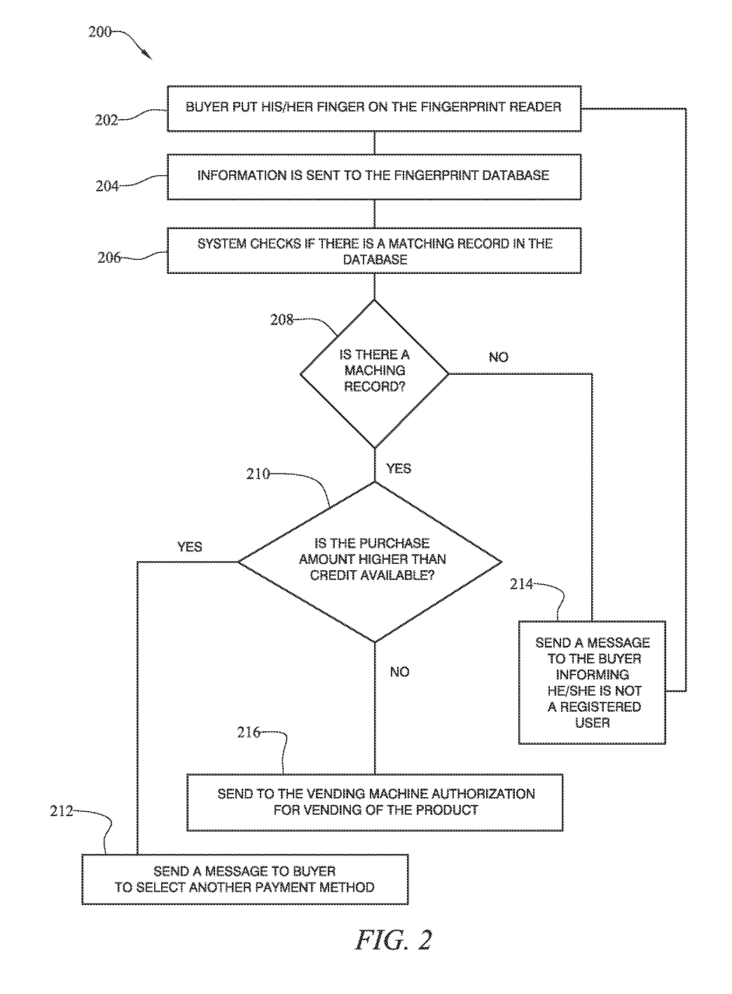

Referring next to FIG. 2 of the drawings, a flow diagram of an illustrative embodiment of a biometric payment and identification method in accordance with the present disclosure is generally indicated by reference numeral 200. The method 200 may be carried out in implementation of the system 10 in FIG. 1. In block 202, a potential buyer of products from the vending machine 20 may place his or her finger on the biometric reader device 21 (FIG. 1). In block 204, biometric information may be transmitted from the biometric reader device 21 to the biometric information database 40 typically via the telecommunication system 30. In blocks 206 and 208, the checking software 41 may determine whether there is a matching biometric record of the potential buyer stored in the biometric information database 40. If a matching biometric record is found in block 208, in block 210 a determination may be made as to whether the purchase amount of a selected product is higher than the credit which is available to the potential buyer for purchase of the selected product. If the purchase amount of the selected product is higher than the available credit, in block 212 a message may be transmitted to the potential buyer and may prompt the potential buyer to select an alternative payment method. If a matching biometric record is not found in block 208, in block 214 a message may be transmitted to the potential buyer and inform the potential buyer that the potential buyer is not a registered user or that the potential buyer does not meet the age and/or other purchase restrictions for purchase of the product.

It will be recognized and understood by those skilled in the art that the method 200 which was heretofore described with respect to FIG. 2 may be a simplification of the actual verification, selection and purchasing process of the method, which may be complex in terms of logical steps and details. In some applications, obtaining a fingerprint from a potential buyer may be replaced by obtaining any other biometric characteristic from the buyer. For example and without limitation, in some applications, the biometric information may include a retinal or iris scan which is obtained from the potential buyer. In some applications, the database 40 may be incorporated into the vending machine 20 and updated every time the vending machine 20 is recharged. Alternatively, the vending machine 20 may be updated remotely via the telecommunication system 30. The database 40 may store one or more fingerprints of a registered user in case the user is unable to use one or more fingers for the verification process. Moreover, the database 40 may be connected to other companies' databases for cross-promotions purposes or to validate eligibility for a product or service. The vending machine 20 could be any machine or electronic equipment that provides a person access to a product or service such as for the purchase of fuel at a gas station, purchase of items at a supermarket, and access to cash from an automatic teller machine (ATM). The system 10 may replace many of the transactions which are currently completed using credit or debit cards.

While the illustrative embodiments of the disclosure have been described above, it will be recognized and understood that various modifications can be made in the disclosure and the appended claims are intended to cover all such modifications which may fall within the spirit and scope of the disclosure.

I claim:

1. A biometric payment and identification system, comprising:
a vending machine;
a biometric reader device communicating with said vending machine;
a biometric information database communicating with said biometric reader device;
checking software supporting said biometric information database and communicating with said vending machine;
said biometric information database is adapted to electronically store biometric information of potential buyers of products contained in said vending machine; and
said checking software is adapted to authorize dispensing of products from said vending machine by matching biometric information obtained from the customer using said biometric reader device with said biometric information stored in said biometric information database.

2. The biometric payment and identification system of claim 1 further comprising a telecommunication system communicating with said biometric reader device and said biometric information database.

3. The biometric payment and identification system of claim 2 wherein said telecommunication system is wireless.

4. The biometric payment and identification system of claim 2 wherein said telecommunication system comprises at least one of a cellular telephone network, a satellite network, hardwired transmission and the Internet.

5. The biometric payment and identification system of claim 1 wherein said biometric information database is adapted to store personal information of the potential buyers with said biometric information stored in said biometric information database and said checking software is adapted to authorize dispensing of products from said vending machine by matching biometric information obtained from the customer using said biometric reader device and analyzing said personal information.

6. The biometric payment and identification system of claim 5 wherein said personal information comprises between others the date of birth of each potential buyer and said checking software is adapted to analyze said date of birth and authorize dispensing of a product from said vending machine if said date of birth meets a predetermined age limit.

7. The biometric payment and identification system of claim 1 wherein said biometric reader device comprises a fingerprint reader device.

8. The biometric payment and identification system of claim 1 wherein said biometric reader device comprises a retinal scanner, a microphone and/or a scanner.

9. A biometric payment and identification system, comprising:
a vending machine;
a biometric reader device communicating with said vending machine;
a biometric information database communicating with said biometric reader device;
checking software supporting said biometric information database and communicating with said vending machine;
said biometric information database is adapted to electronically store biometric information and payment information of potential buyers of products contained in the vending machine;
said checking software is adapted to authorize dispensing of products from said vending machine by matching biometric information obtained from the customer using said biometric reader device with said biometric information stored in said biometric information database; and
said checking software is adapted to debit payment of products dispensed from said vending machine using said payment information.

10. The biometric payment and identification system of claim 9 further comprising a telecommunication system communicating with said biometric reader device and said biometric information database or with other company databases.

11. The biometric payment and identification system of claim 10 wherein said telecommunication system is wireless.

12. The biometric payment and identification system of claim 10 wherein said telecommunication system comprises at least one of a cellular telephone network, a satellite network, hardwired transmission and the Internet.

13. The biometric payment and identification system of claim 9 wherein said biometric information database is adapted to store personal information of the potential buyers with said biometric information stored in said biometric information database and said checking software is adapted to authorize dispensing of products from said vending machine by matching biometric information obtained from the customer using said biometric reader device and analyzing said personal information.

14. The biometric payment and identification system of claim 13 wherein said personal information comprises between others the date of birth of each potential buyer and said checking software is adapted to analyze said date of birth and authorize dispensing of a product from said vending machine if said date of birth exceeds a predetermined age limit.

15. The biometric payment and identification system of claim 9 wherein said biometric reader device is a fingerprint reader device or a retinal scanner.

16. The biometric payment and identification system of claim 9 wherein said payment information comprises at least one of credit card information, debit card information and bank account information.

17. A biometric payment and identification method, comprising:
obtaining a database of biometric information from potential buyers of products subject to at least one purchase restriction;
obtaining biometric information from a potential buyer of one of the products;
determining a match between said biometric information from said database and said biometric information from a potential buyer of one of the products; and
validating sale of said one of the products upon obtaining said match if there is a restriction on the sale of that product or validate the payment methods registered in the data base or promotions if the product has no restrictions.

18. The method of claim 17 wherein said obtaining a database of biometric information from potential buyers of products subject to at least one purchase restriction comprises obtaining a database of fingerprints or a retinal iris scan.

19. The method of claim 17 further comprising obtaining payment information from said potential buyers of products, a purchase price of said one of the products by the purchase price of the product bought and debiting a purchase price of said one of the products using said payment information.

20. The method of claim 17 further comprising providing at least one vending machine and wherein validating sale of said one of the products upon obtaining said match, buying one unrestricted product using payment information or for receiving promotions comprises dispensing said one of the products from said at least one vending machine.
